(19) United States
(12) Patent Application Publication
(10) Pub. No.: US 2015/0095708 A1
(43) Pub. Date: Apr. 2, 2015

(54) AUTOMATIC GENERATION OF ENTITY TYPES FILES

(71) Applicant: Ali Kanso, Ville Saint Laurent (CA)

(72) Inventor: Ali Kanso, Ville Saint Laurent (CA)

(73) Assignee: TELEFONAKTIEBOLAGET L M ERICSSON (PUBL), Stockholm (SE)

(21) Appl. No.: 14/044,240

(22) Filed: Oct. 2, 2013

(51) Int. Cl. G06F 11/36

(52) U.S. Cl. CPC G06F 11/3604
USPC 714/38.1

(57) ABSTRACT

An Entity Types File (ETF) is automatically generated from a high-level software description, where the software description describes software to be managed by middleware to achieve high availability. An ETF generation method comprises receiving the software description that describes interfaces and dependency between components of the software; verifying the software description in accordance with constraints imposed by middleware specifications; based on the verified software description, automatically creating a hierarchy of entity types and associations among the entity types compliant with the middleware specifications; and outputting the entity types and the associations as the ETF for subsequent generation of a configuration of the middleware for availability management.

### TECHNICAL FIELD

Embodiments of the invention relate to availability management; and more specifically, to the use of high availability middleware for managing system availability.

### BACKGROUND

The Service Availability Forum (also referred to as “SA Forum” or “SAF”) defines a set of specifications for a High Availability (HA) middleware. The core of this middleware is the Availability Management Framework (AMF). AMF is responsible for monitoring the components, detecting failures, and reacting to failures. AMF performs this availability management according to a system configuration known as the AMF configuration. An AMF configuration is a logical organization of the software components describing how they are grouped, their dependencies, the services they provide, and the recovery policy that AMF applies in case of failure.

In the following, the main elements of an AMF configuration will be described. The basic building block of an AMF configuration is an AMF component (also referred to as a component), which abstracts a deployable instance of an application's component. The service(s) provided by such a component is represented by a component-service-instance. The components that collaborate closely and that must be collocated to provide a more integrated service are grouped into a service-unit. The workload assigned to the service-unit is referred to as the service-instance, which is a grouping of component-service-instances. The service-units composed of redundant component replicas form a service-group. The service availability management takes place within the service-group; i.e., the service instances are provided by service-units and protected against failures within the scope of the service-group. The AMF configuration also represents the nodes on which the components are deployed. AMF supports the notion of a redundancy model for a service-group. The redundancy model defines the redundancy scheme according to which the service-instances are protected. For instance, a 2N (one active and one standby) redundancy dictates that the service-group can have one active service-unit for all the service-instances and one standby for all the service-instances; i.e., a service-unit cannot simultaneously be active for some service-instances and standby for others.

FIG. 1 illustrates an example AMF configuration, in which there is one service-group (SG) with 2N redundancy. The service-group (SG1) contains two redundant service-units (SU1 and SU2), deployed on nodes Node1 and Node2, respectively. One service-unit is active and one is in standby, ready to take over if the active one fails. Each service-unit (SU1 or SU2) has two components ((C1 and C2) for SU1; (C3 and C4) for SU2). The service-group (SG1) protects two service-instances (SI1 and SI2). Each service-instance is composed of two component-service-instances ((CSI1 and CSI2) for SI1; (CSI3 and CSI4) for SI2). The AMF configuration also contains attributes that can determine the recovery executed by AMF at runtime in case a failure of a component or service instance is detected. All of the elements shown in FIG. 1 are represented by objects in the AMF configuration. The structure of these objects complies with a Unified Modeling Language (UML) class diagram. The configuration objects are described according to a standardized machine-readable eXtensible Markup Language (XML) schema. It is the responsibility of a system integrator to define the AMF configuration.

To interact with AMF, a software application implements the specific Application Programming Interfaces (APIs) defined by the SAF specifications; i.e., the API implementation is incorporated in the application's code. This requires the application developer to have detailed knowledge of the APIs and the SAF domain in general, and to implement these APIs. The software components that implement these APIs are known as SA-aware (service availability aware).

Except for the nodes and clusters, all the other AMF configuration entities are typed. The types include vital information about the entities; such information is used by AMF to manage the entities. For instance, the component type defines the component category (e.g., independent SA-aware (that is, SA-aware but not a container/contained or proxy/proxied), proxied, contained, etc.). Managing a proxied component (which, by definition, does not implement the SAF APIs) means that the middleware goes through the proxy when interacting with the proxied component, which is different than managing a contained component that does implement the SAF APIs. The container role is rather limited compared to the proxy role; however, when the container fails, it has a direct impact on the contained component since it constitutes their execution environment, while the failure of the proxy has limited impact on the health of the proxied component. In short, the attributes and the constraints applied to each component category are different.

The AMF types are derived from ETF types provided by software vendors or providers. The ETF types are defined in one or more Entity Types Files (ETFs, also referred to as ETF files). The ETF is a description of the software bundle in terms of capability, compatibility, upgradability, etc. The ETF file is defined by a software vendor/provider that wishes to have his software managed by the SAF middleware. Hence, the ETF file is an essential input for generating AMF configurations. Existing methods for generating AMF configurations assume the existence of ETFs, where the ETFs are based on a standardized XML schema described in the SAF specifications.

An existing approach tackles the problem of generating AMF configurations by bridging the gap between high level user requirements and the middleware configuration requirements (e.g., see U.S. Pre-Grant Publication 20130091485, “Bridging the Gap Between High Level User Requirements and Availability Management Framework Configurations” by Colombo et al.). The existing approach assumes the existence of an ETF with at least the component types and the component service types already defined with their explicit dependencies and associations. However, the vast majority of existing applications are not developed with the intention of being managed by the SAF middleware, and the vast majority of software developers are not aware of the details of the SAF specifications and the structures and constraints imposed on the definition of ETF files. Thus, there is a wide range of applications that do not have accompanied ETF files.

### SUMMARY

In one embodiment, there is provided a method for automatically generating an ETF from a high-level software description, wherein the software description describes software to be managed by middleware to achieve high availability. The method comprises the steps of receiving the software description that describes interfaces and dependency between components of the software; verifying the software description in accordance with constraints imposed by middleware specifications; based on the verified software description, automatically creating a hierarchy of entity types and associations among the entity types compliant with the middleware specifications; and outputting the entity types and the associations as the ETF for subsequent generation of a configuration of the middleware for availability management.

In another embodiment, there is provided a computer system adapted to automatically generate an ETF from a high-level software description, wherein the software description describes software that is to be managed by middleware to achieve high availability. The computer system comprises a processor and a memory. The memory contains instructions executable by the processor. The computer system is operative to: receive the software description that describes interfaces and dependency between components of the software; verify the software description in accordance with constraints imposed by middleware specifications; based on the verified software description, automatically create a hierarchy of entity types and associations among the entity types compliant with the middleware specifications; and output the entity types and the associations as the ETF for subsequent generation of a configuration of the middleware for availability management.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of a middleware configuration that may be generated according one embodiment.

FIG. 2 is a block diagram illustrating an overall view of the configuration generation according to one embodiment.

FIG. 3 illustrates an example of UML component diagram.

FIG. 4 illustrates added extension to the UML according to one embodiment.

FIG. 5A illustrates an example of an invalid component model from the perspective of the SA Forum.

FIG. 5B illustrates an example of a valid component model.

FIG. 5C illustrates another example of a valid component model.

FIG. 6 is a flow diagram illustrating an input process for validating a component model according to one embodiment.

FIG. 7 illustrates an example of a high-level software description based on an extended UML component diagram according to one embodiment.

FIG. 8 illustrates transforming the extending UML component diagram of FIG. 7 into an ETF file according to one embodiment.

FIG. 9 illustrates a method for automatically generating an ETF file according one embodiment.

FIG. 10 illustrates a block diagram of a computer system according to one embodiment.

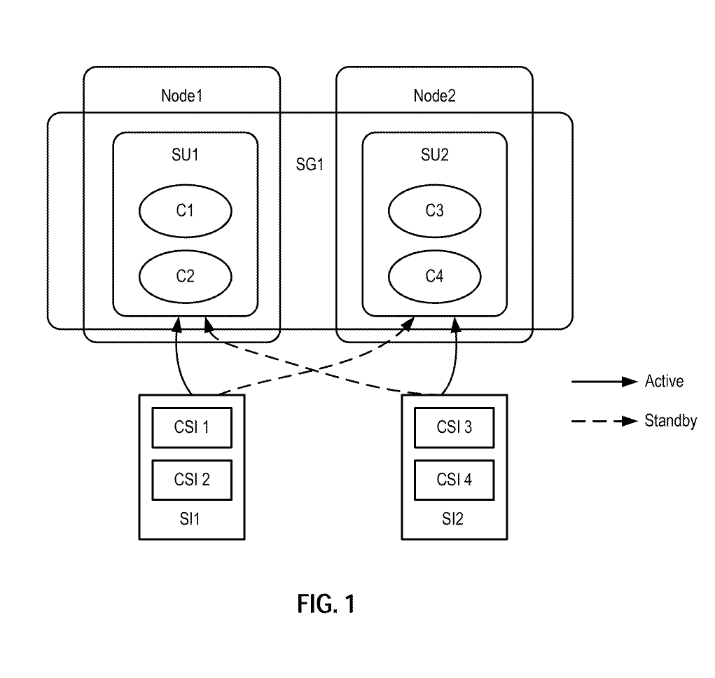

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The SAF specification describes an HA middleware capable of managing the availability of software applications based on a middleware configuration describing these applications. This middleware configuration is heavily based on the types described in an ETF. An ETF is a file describing the software application(s) capabilities, limitations, dependencies, etc. through the use of types (e.g., component types, service types, etc.). An ETF describes a hierarchy of entity types compliant with the middleware specifications. The SA Forum defines a standard XML schema, based on which the ETF file is defined. Creating this XML file is a complex task that requires deep knowledge of the SAF specifications.

Embodiments of the invention provide a system and method for automatically generating a non-existing ETF file with minimum knowledge of the domain defined by the SA Forum. According to embodiments of the invention, a software application can be provided to a user without an ETF file and managed by an SAF middleware (e.g., AMF). The system and method described herein is generic and targets a wide range of applications. Moreover, embodiments of the invention enable applications that do not implement the SAF APIs to become highly available on demand.

In one embodiment, the automatic generation of ETF files is based on three pillars: (1) the extension to a common modeling language that is familiar to the majority of software developers (e.g., the Unified Modeling Language (UML)); (2) the use of the constraints defined in the SAF specification to validate the UML model with extended constructs (also referred to as the “extended UML Component Diagram”); and (3) a system and method that enables the automatic generation of ETF files based on an instance of the extended UML Component Diagram describing the applications provided by software vendors or providers.

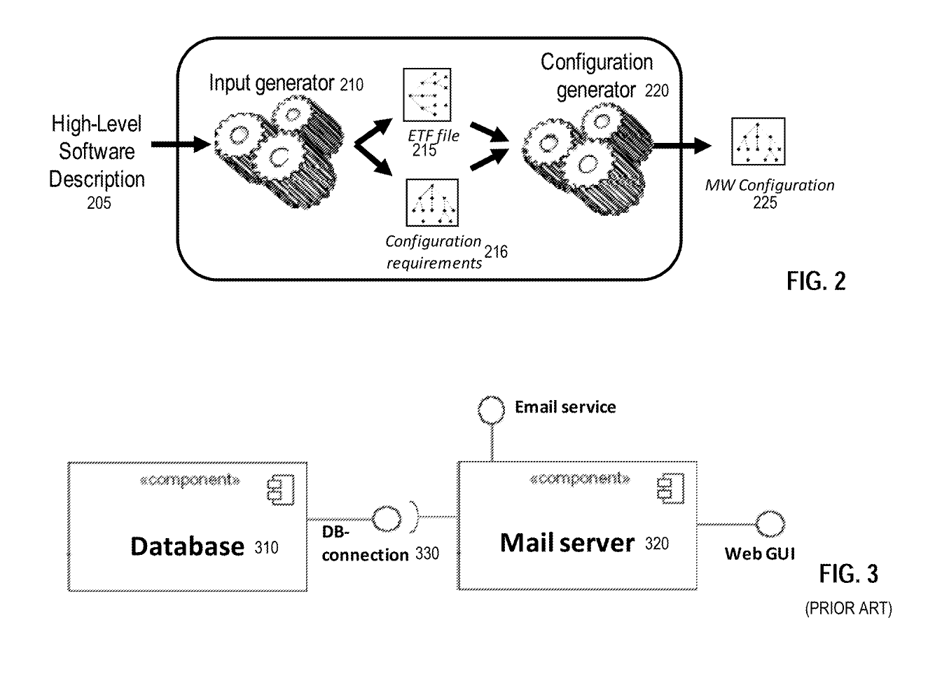

As will be described in detail below, embodiments of the invention not only automate the generation of ETF files, but also automate the input to a configuration generator. FIG. 2 illustrates an example of an input generator 210 and a configuration generator 220 according to one embodiment of the invention. The input generator 210 receives a high-level software description 205, which describes a software application to be added to a highly available system. The high-level software description 205 may be provided by a cloud user, a system administrator/integrator, or anyone (collectively referred to as a “user”) who wishes to use an application in a high-availability manner. In some scenarios, a “user” may be a software provider or designer. It is assumed herein that the high-level software description 205 is not in the form of an ETF file; therefore, the user needs an ETF to be generated in order to generate a middleware configuration. From the software description 205, the input generator 210 generates one or more ETF files 215 and configuration requirements 216. The configuration generator 220 receives the ETF files 215 and the configuration requirements 216, and generates a middleware configuration 225 (e.g., an SAF middleware configuration such as an AMF configuration). An example of the configuration generator 220 is described in U.S. Pat. No. 8,006,130. The middleware configuration 225 may be input into an upgrade campaign generator, which generates an upgrade campaign file. The upgrade campaign file may be used by the middleware to install the software application.

The UML is the de-facto modeling language in the software engineering field; it defines a set of graphic notations or diagrams that can visually model the structure and behavior of complex systems. The UML component diagram depicts how the various components of a software system are linked together. A UML component represents a subsystem (e.g., a software entity) that can interact with other system components by providing or consuming services using its interfaces. FIG. 3 shows an example using the main constructs of the UML component diagram. In this example there are two components, a database (DB) 310 and a mail server 320. The database 310 offers its service through a DB-connection interface 330. The mail server 320 offers the Email service and the Web Graphical User Interface (GUI), and it requires the DB-connection 330 (e.g., to store and retrieve the emails in/from the DB 310).

The SAF interface implicitly describes interfaces that are not defined by the generic interface supported by the UML. It is “implicit” because the SAF specifications refer to a component category without stating the interfaces it provides. Nonetheless, an SA-aware component should implement an SAF interface that implements the needed SAF APIs. For instance, when a component provides the SAF interface it means that the component is SA-aware and should include certain attributes and comply to constraints associated with the SA-aware category, and that the component is allowed to provide other interfaces implicitly defined by the SA Forum such as the proxy or container.

Each software application may have a different organization, architecture and high availability requirements; therefore, a generic model is needed that allows the software developers to describe their applications and the availability requirements. The advantage of using a generic model is that is allows to an automated process to transform a high-level software description into the input of a configuration generator, which can automatically generate the middleware configuration as shown in FIG. 2.

In order to enable the user to define an input describing its application using component diagrams, the UML is extended with additional constructs that capture specific semantics in the context of the SAF domain. Thus, these extensions relieve the user from having to learn the SAF specifications, and allow the user remains at a generic level of modeling its application.

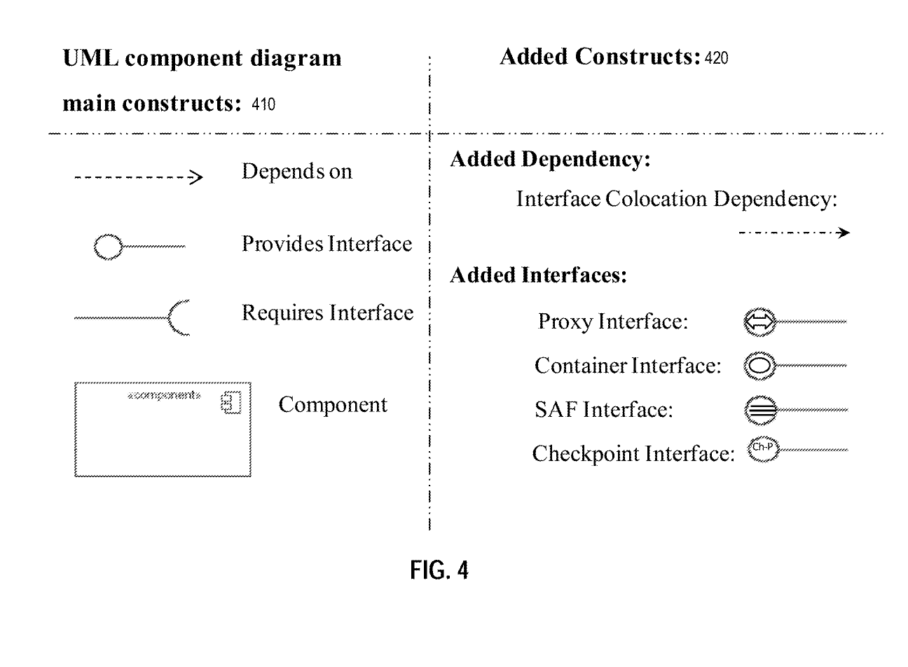

FIG. 4 illustrates an embodiment of added constructs in an extended UML component diagram. The extension adds semantics and domain-specific constructs to the UML, through the use of stereotypes, tag definitions and constraints which are applied to specific model elements such as classes or attributes. In an extended UML component diagram, the added interfaces map to the UML standard interface with added semantics. The extension also adds interface colocation dependency to the UML. The interface colocation dependency also maps to the standard dependency with added semantics. The added semantics are described in the following.

Both the component and the interface inherit from the UML Class, i.e., they can have attributes, associations, and can be constrained. For each component (regardless of its category), mandatory information is added to the component such as the version name and the instantiate command (which are common attributes). However, based on the interfaces that the designer adds to the component, the list of attributes will change accordingly, e.g., if the SAF interface is added to the component, this means that the component implements the SAF APIs and thus there is no need to specify the terminate command line interface (CLI) command. This is because the middleware will do the termination using the API and not the CLI command. The interface as well, will have its attributes describing its name, version, and capabilities (e.g., number of active/standby assignments it can handle).

The extension to the UML adds at least constructs 420 to UML component diagram main constructs 410. The constructs 420 include: interface colocation dependency, SAF interface, proxy interface, container interface and checkpoint interface. Additional interfaces and dependency may also be included.

Interface colocation dependency: this dependency signifies that the components related by this dependency must reside in the same service unit (on the same execution environment in the same physical machine); i.e., the types of these components must be grouped by the same service unit type. This dependency also implies that the redundancy specified by the software designer for the implicated components is the same; i.e., if one component requires an active/active redundancy, the other cannot require an active/standby dependency (as there is no AMF redundancy model that supports multiple actives and multiple standbys). The rationale behind this constraint is that these components will later be grouped in the service unit that belongs to a service group supporting a single redundancy model supporting either (1) multiple active assignments for a given service, or (2) one active with zero or more standbys, but not both. The interface collocation dependency may be formed between two or more components. A chain of interface collocation dependency can be formed by multiple components, where each one provides an interface needed by the interface of another.

SAF interface: a component providing this interface implements the SAF APIs, and therefore can register and interact with the middleware. This is a pre-requisite interface for a configuration to provide the below described interfaces.

Proxy interface: a component providing this interface mediates the interactions between the middleware and a proxied component. Therefore, the component providing the proxy interface must also provide the SAF interface. If a component requires this proxy interface, it means that it is a proxied component that does not implement the SAF interface. It also means that if a proxied component is pre-instantiable, then it should not be colocated in the same service unit as the proxy component. Therefore, a pre-instantiable proxied component should not be associated with a proxy component using the interface colocation dependency.

Container interface: a component providing the container interface can serve as an execution environment to other components referred to as contained components. Both the container and contained components must provide the SAF interface, and all the contained components in one service unit must have the same container.

Checkpoint interface: this is an added interface (not described in the SA Forum specifications). A component providing this interface also implements the SAF interface. Using this interface, a component that does not implement the SAF interface can use the middleware checkpoint service by requiring this interface. A checkpoint agent, which provides the checkpoint interface, receives the checkpoint request from the component through the checkpoint interface, and forwards the request to the middleware checkpoint service using the SAF interface.

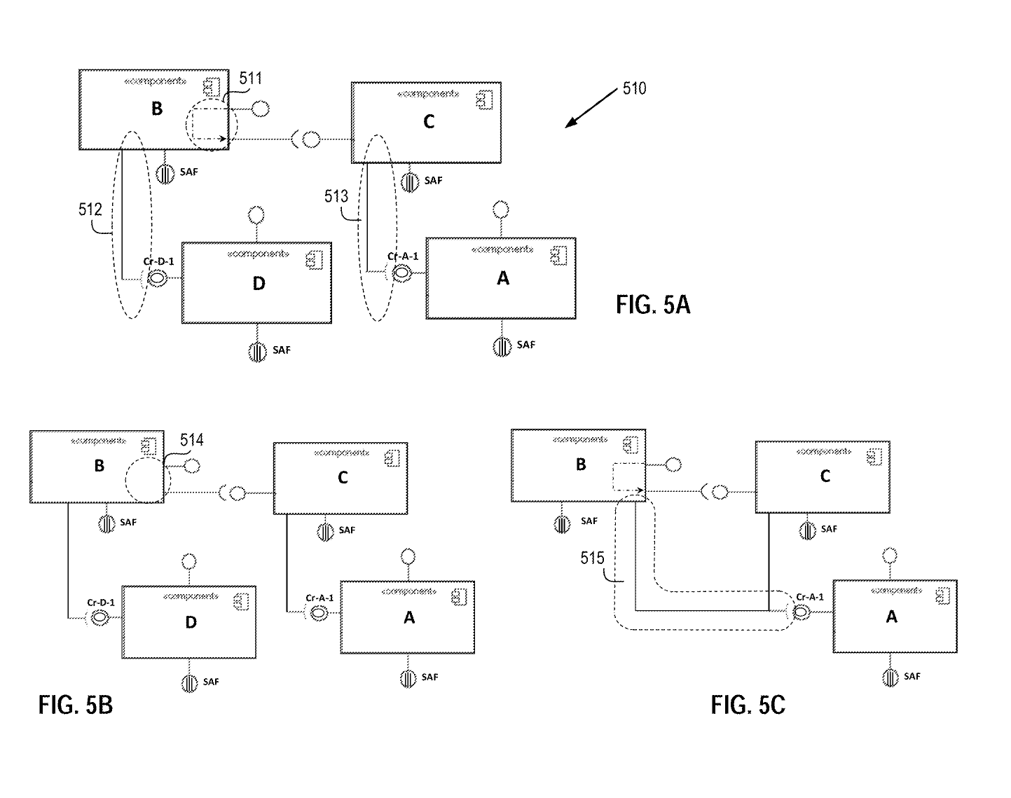

A software developer may well be aware of the interfaces of its components and their functionalities, but not necessarily aware of the constraints imposed on how the components can be grouped and connected. In one embodiment, a component model of a software design is validated based on a set of constraints extracted from the SAF specifications. FIGS. 5A-C illustrate an example of validating a component model according to an embodiment of the invention. FIG. 5A is an example of an invalid model 510, from the perspective of the SA Forum. The model 510 is invalid because the interface colocation dependency 511 implies that components B and C reside in the same service unit, while each one of them specifies a different container (indicated by container interfaces Cr-A1 in 512 and Cr-D1 in 513), which is in violation of the AMF specifications of the SA Forum stating that all the contained components of the same service unit have the same container. The violation can be fixed by either removing the interface colocation dependency 510 (shown in 514 of FIG. 5B) or by specifying the same container (shown in 515 of FIG. 5C).

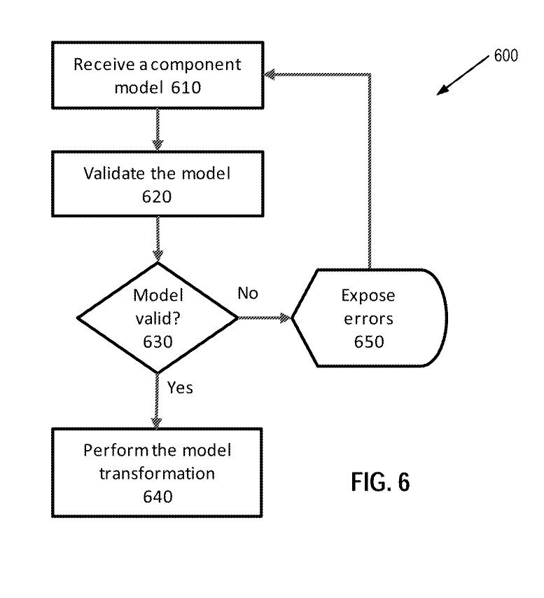

FIG. 6 illustrates an example of an input process 600 according to embodiments of the invention. The input process 600 may be performed by software, hardware, or a combination of both. In some embodiments, the input process 600 is performed by a computer system, by a network node, or other automated machinery. In one embodiment, the input process 600 starts with receiving a component model that describe a software application design in an extended UML component diagram (block 610). The component model is validated (block 620); if it is invalid (e.g., when an invalid configuration is detected) (block 630), an error message is generated (block 640) and the process return to block 610. If the component model is valid (block 630), a model transformation is performed (block 650) to generate an ETF file.

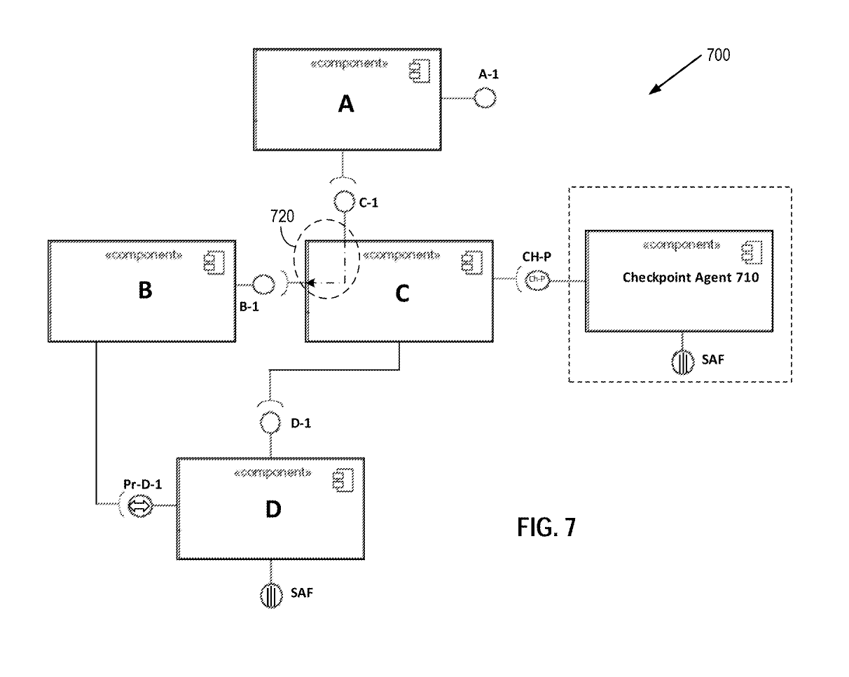

FIG. 7 illustrates an example of an extended UML component diagram 700 according one embodiment of the invention. In this example, a designer models its application to include four components (A,B,C,D), where each component provides one or more services through their respective “provides” interfaces (A-1, B1, C-1, D-1). The designer also specifies a set of attributes for each component (e.g., the instantiate/cleanup commands, the number of active/standby/spare instances needed (i.e., redundancy), the preferred resource allocation for the component, etc.). Part of these attributes will be mapped to the ETF file generated based on the component diagram 700; part of the attributes will be used to create the configuration requirements. In this example, an interface collocation dependency 720 exists between components B and C. Component D offers a proxy interface Pr-D-1. A checkpoint agent 710 (shown in a dotted box) provides a checkpoint interface CH-P. Note that the checkpoint agent 710 is not part of the user's application. Rather, the checkpoint agent 710 interfaces with the user's software components (A,B,C,D) to provide service continuity and high availability to the software. The user can specify in the diagram that he/she requires this interface for certain components.

Table 1 illustrates, at a high level of abstraction, an embodiment of a method for generating the ETF file. Alternative embodiments may include variations to the method to accommodate different user preferences. Some of the following steps may be optional; e.g., certain orphan independent component types are not necessarily grouped by service unit types. In some embodiments, service group types and/or application types may be omitted.

TABLE 1
ETF generation method

| Step | Action |
|---|---|
| Creating | For each UML component create an ETF component |
| Component | type. |
| Types | For each provided interface of the component, create |
| (CTs) and | an ETF component service type, and associated with |
| Component | the component type through the <<provides>> |
| Service | relationship. |
| Types | For each interface colocation dependency create a |
| (CSTs) | CT-CST dependency. |
| Creating | For each set of CTs, connected through the CT-CST |
| Service | dependency, create an ETF service type that groups |
| Types | (i.e. through the <<groups>> relationship) all the |
| (SvcTs) | CSTs provided by the set of CTs. |
| | For each independent CT, create a service type that |
| | groups all the CSTs provided by the independent CT. |
| Creating | For each set of CTs connected through the CT-CST |
| Service | dependency create an ETF service unit type that |
| Unit Types | groups all the CTs implicated in the dependency. |
| (SUTs) | For each independent CT, create a service unit type |
| | that groups the CT. |
| | For each SvcT where all its CSTs are provided by the |
| | set of CTs of the SUT, associate the SUT and the |
| | SvcT through the <<provides>> relationship. |
| | For each provided SvcT (by the SUT) that groups a |
| | CST provided by a CT (derived from a UML |
| | component) that requires (through the “require” UML |
| | interface) an interface from a different CT (derived |
| | from a UML component) that provides a CST |
| | grouped by a different SvcT, create a SUT-SvcT |
| | dependency relationship. |
| Creating | For each SUT, create an ETF service group type that |
| Service | groups it (can be changed based on preferences). |
| Group Types | |
| (SGTs) | |
| Create | For all the SGTs grouping the user's components, |
| Application | create an ETF application type that groups them (can |
| Types | be changed based on preferences). |
| Create a | Create an ETF software bundle that the ETF CTs can |
| software | reference. |
| bundle | |

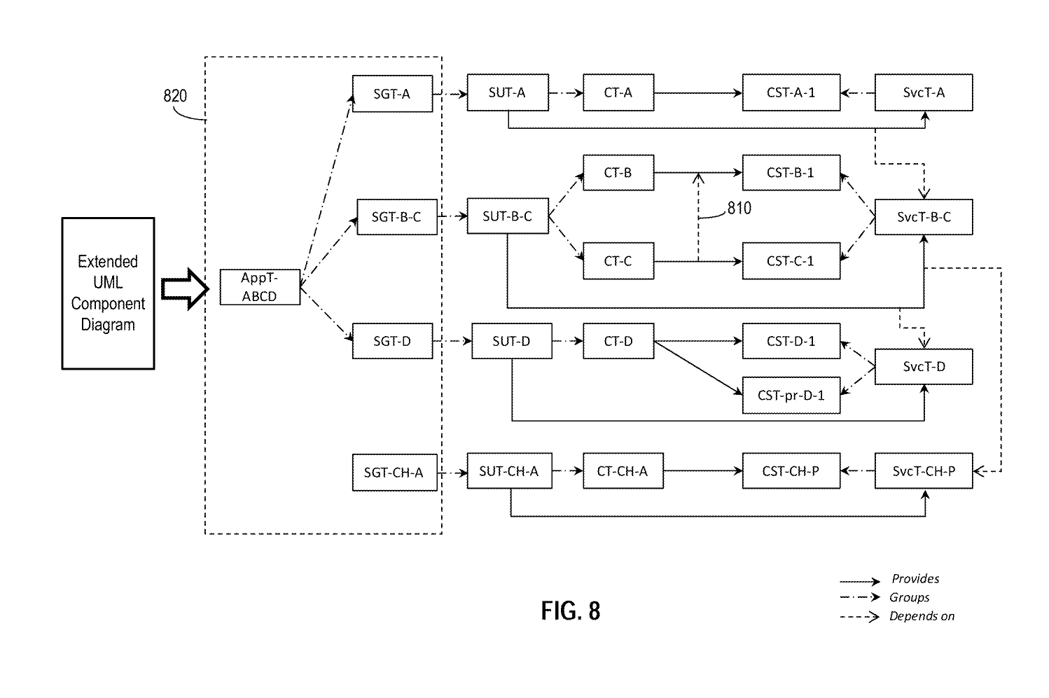

FIG. 8 illustrates an example of a transformation that transforms a user specified component diagram of FIG. 7 into an ETF file, according one embodiment of the invention. This example shows the generated ETF file content. The transformation is performed based on the method of Table 1. In the example of FIG. 8, the first step is to map each component in the extended UML component diagram with its relevant attributes into an ETF component type (creating CT-A, CT-B, CT-C, CT-D, CT-CH-A, corresponding to components A, B, C, D and the checkpoint agent 710, respectively). Then for each provided interface (except the SAF interface), create a component service type (creating CST-A-1, CST-B-1, CST-C-1, CST-D-1, CST-pr-D-1, CST-CH-P). Thereafter, the “provides” relation between the CTs and the CSTs is created. Note that due to the interface colocation dependency 720, a dependency 810 between the “provides” relations is also created. In the case of CT-B and CT-C, for example, this dependency 810 is interpreted as: in order for CT-C to provide CST-C-1, it requires CT-B to provide CST-B-1.

The next steps are the definition of the service unit types and the service types. Both groupings are based on the colocation dependencies defined at the CT level, where for all the CTs associated through this dependency, a service unit type is created to ensure the colocation of the components of those CTs in the service unit (creating SUT-A, SUT-B-C, SUT-D, SUT-CH-A). These service unit types are linked to the corresponding components through the “groups” relation. For all CSTs related by the interface colocation dependency, a service type grouping (through the “groups” relation) these CSTs is created to ensure that the CSIs of these CSTs are assigned to the same service unit (creating SvcT-A, SvcT-B-C, SvcT-D, SvcT-CH-P). Next, the “provides” association is created between the service unit types and the service types. The next step is to handle the dependencies in the UML component diagram reflected by the “requires” interface. This dependency is captured through the use of the dependency between the “provides” association of the service unit type and the service type and another service type. Note that this dependency is captured and interpreted differently from the interface colocation dependency, where in the “requires” dependency, any service unit type providing the sponsor service type is a valid choice; moreover, the colocation in the same service unit on the same node is dropped.

The examples presented so far consider all of the created types needed in order to capture the semantics and constraints of the extended UML component diagram. An ETF file does not need to include all of the types (e.g., the service group type and the application type as shown in the dotted box 820 are optional). However, in some cases this complete creation can be useful to further guide the use of these types in the configuration generation (i.e., limiting the various configuration options). For this purpose, in one embodiment, the creation of the service group types and the application types based on the designer preference is offered.

Service group type creation preference:

1. For each service unit type, create a service group type (as shown in Table 1).

2. For each set of service unit types that groups components with the same redundancy requirements, create a service group type; e.g., if two service unit types are grouping CTs derived from UML components on which the designer requires “one active and one standby” redundancy, then the service unit types can be in the same service group type.

Application Type Creation Preference:

1. For each service group type, create an application type (as shown in Table 1).

2. For each set of service unit types related to another service unit type by a dependency relation (though the provision of a service type), create an application type grouping their service group types. This implies the use of the above-mentioned preference of the creation of the service group types.

In addition to the ETF generation, a high-level software description can also be used to generate configuration requirements. As shown in the embodiment of FIG. 2, the inputs needed for generating a middleware configuration include: (1) an ETF file, and (2) configuration requirements in terms of templates (e.g., service instance and component service instance templates). Based on the information specified in the component these templates can be easily generated. As a simplified example, one service-instance is generated per active service-unit, e.g., if, for component D in FIG. 7, the user specifies a redundancy model of 3 active+1 standby, then a service-instance template of 3 service-instances is defined, where each service instance includes one component-service-instance of each CST provided by component D.

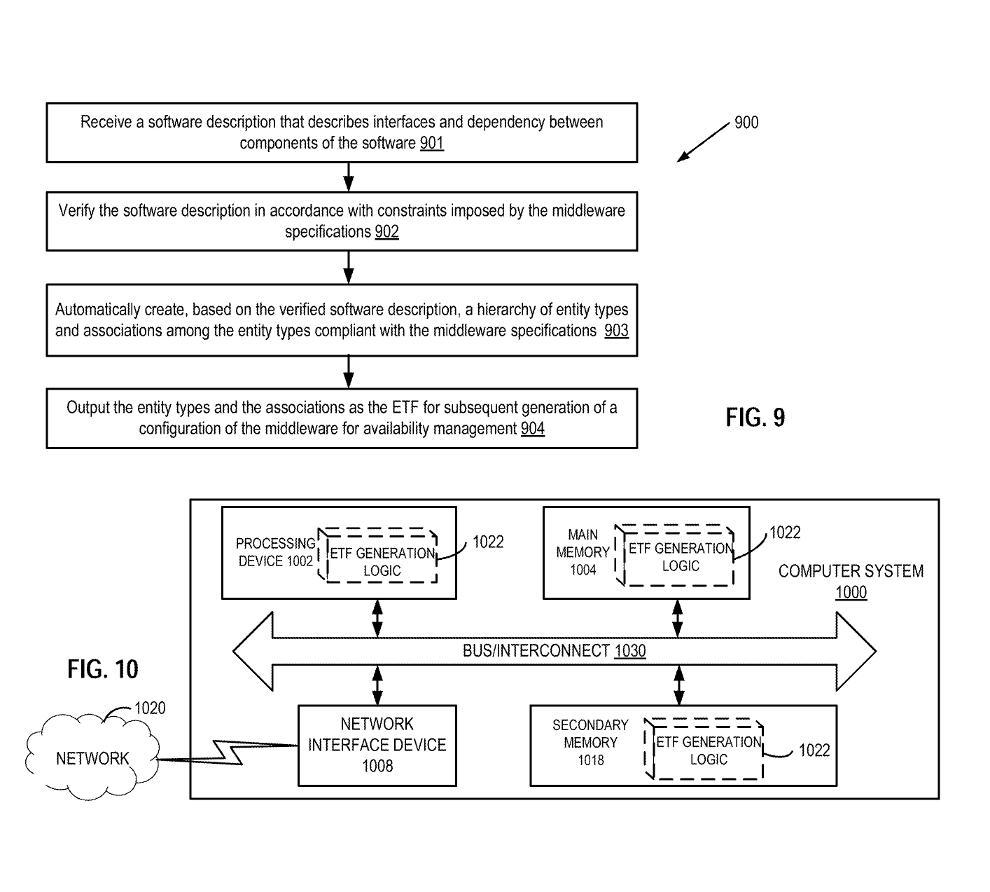

FIG. 9 is a flow diagram illustrating a method 900 for automatically generating an ETF from a high-level software description, wherein the software description describes software to be managed by middleware to achieve high availability. Referring to FIG. 9, in one embodiment, the method 900 begins with a computer system receiving the software description that describes interfaces and dependency between components of the software (block 901). The computer system then verifies the software description in accordance with constraints imposed by middleware specifications (block 902). Based on the verified software description, the computer system automatically creates a hierarchy of entity types and associations among the entity types compliant with the middleware specifications (block 903). The computer system then outputs the entity types and the associations as the ETF for subsequent generation of a configuration of the middleware for availability management (block 904).

The method 900 may be performed by hardware (e.g., circuitry, dedicated logic, programmable logic, microcode, etc.), software (e.g., instructions run on a processing device), or a combination thereof. In one embodiment, the method 900 is performed by a computer system 1000 of FIG. 10. In one embodiment, the computer system 1000 may be part of a network node (e.g., a router, switch, bridge, controller, base station, etc.). In one embodiment, the computer system 1000 may be part of a cloud computing system.

FIG. 10 illustrates a diagrammatic representation of a machine in the exemplary form of the computer system 1000 within which a set of instructions, for causing the machine to perform any one or more of the methodologies discussed herein, may be executed. The computer system 1000 may be a server computer, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system 1000 includes a processing device 1002. The processing device 1002 represents one or more general-purpose processors, each of which can be: a microprocessor, a central processing unit (CPU), a multicore system, or the like. More particularly, the processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. In one embodiment, the processing device 1002 is adapted to execute the operations of an ETF generation logic 1022 which contains instructions executable by the processor device 1002 to perform the method 900 of FIG. 9 for automatic ETF generation.

In one embodiment, the computer system 1000 is adapted to automatically generate an ETF from a high-level software description, wherein the software description describes software that is to be managed by middleware to achieve high availability. The computer system 1000 is operative to perform the method 900 of FIG. 9 of receiving the software description that describes interfaces and dependency between components of the software; verifying the software description in accordance with constraints imposed by middleware specifications; based on the verified software description, automatically creating a hierarchy of entity types and associations among the entity types compliant with the middleware specifications; and outputting the entity types and the associations as the ETF for subsequent generation of a configuration of the middleware for availability management.

In one embodiment, the processor device 1002 is coupled to one or more memory devices such as: a main memory 1004 (e.g., read-only memory (ROM), flash memory, dynamic random access memory (DRAM) such as synchronous DRAM (SDRAM) or Rambus DRAM (RDRAM), etc.), a secondary memory 1018 (e.g., a magnetic data storage device, an optical magnetic data storage device, etc.), and other forms of computer-readable media, which communicate with each other via a bus or interconnect 1030. The memory devices may also include different forms of read-only memories (ROMs), different forms of random access memories (RAMs), static random access memory (SRAM), or any type of media suitable for storing electronic instructions. In one embodiment, the memory devices may store the code and data of the ETF generation logic 1022. In the embodiment of FIG. 10, the ETF generation logic 1022 may be located in one or more of the locations shown as dotted boxes and labeled by the reference numeral 1022. In alternative embodiments the ETF generation logic 1022 may be located in other location(s) not shown in FIG. 10.

The computer system 1000 may further include a network interface device 1008. A part or all of the data and code of the ETF generation logic 1022 may be transmitted or received over a network 1020 via the network interface device 1008.

In one embodiment, the ETF generation logic 1022 can be implemented using code and data stored and executed on one or more computer systems (e.g., the computer system 1000). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory) and transitory computer-readable transmission media (e.g., electrical, optical, acoustical or other form of propagated signals—such as carrier waves, infrared signals). A non-transitory computer-readable medium of a given computer system typically stores instructions for execution on one or more processors of that computer system.

The operations of the flow diagram of FIG. 9 have been described with reference to the exemplary embodiment of FIG. 10. However, it should be understood that the operations of the flow diagram of FIG. 9 can be performed by embodiments of the invention other than those discussed with reference to FIG. 10, and the embodiment discussed with reference to FIG. 10 can perform operations different than those discussed with reference to the flow diagram. While the flow diagram of FIG. 9 shows a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for automatically generating an Entity Types File (ETF) from a high-level software description, wherein the software description describes software to be managed by middleware to achieve high availability, the method comprising the steps of:
receiving, by a computer system, the software description that describes interfaces and dependency between components of the software;
verifying the software description in accordance with constraints imposed by middleware specifications;
automatically creating, based on the verified software description, a hierarchy of entity types and associations among the entity types compliant with the middleware specifications; and
outputting, by the computer system, the entity types and the associations as the ETF for subsequent generation of a configuration of the middleware for availability management.

2. The method of claim 1, wherein the step of automatically creating further comprises the steps of:
mapping a component of the software into an ETF component type;
mapping an interface provided by the component of the software into a component service type; and
associating the component service type with the ETF component type.

3. The method of claim 2, wherein the step of automatically creating further comprises the steps of:
creating a service type that groups all of the component service types provided by an independent ETF component type.

4. The method of claim 1, wherein the interfaces and dependency include an interface collocation dependency between multiple components of the software, wherein the multiple components are mapped to corresponding ETF component types having associated ETF component service types, the step of automatically creating further comprising the steps of:
creating a service type that groups the associated component service types; and
creating a service unit type that groups the corresponding ETF component types.

5. The method of claim 1, wherein the step of verifying further comprises the steps of:
generating an error indication when the software description violates at least one of the constraints imposed by the middleware specifications; and
automatically creating the ETF when no error is detected in the software description.

6. The method of claim 1, wherein the interfaces include a provides interface through which a component provides service, and a requires interface indicating that a component requires service.

7. The method of claim 1, wherein the interfaces and dependency include one or more of the following: a middleware interface for registering and interacting with the middleware, a proxy interface provided by a proxy component that mediates interactions between the middleware and a proxied component, and a container interface provided by a container component that serves as an execution environment to contained components.

8. The method of claim 1, wherein the interfaces and dependency include a checkpoint interface, which is provided by a checkpoint agent to deliver checkpoint service of the middleware to a component.

9. The method of claim 1, wherein the step of automatically creating further comprises the step of generating configuration requirements from the verified software description.

10. The method of claim 1, wherein the software description is in a modeling language extended from a Unified Modeling Language (UML).

11. A computer system adapted to automatically generate an Entity Types File (ETF) from a high-level software description, wherein the software description describes software that is to be managed by middleware to achieve high availability, the computer system comprising a processor and a memory, the memory containing instructions executable by the processor, wherein the computer system is operative to:
receive the software description that describes interfaces and dependency between components of the software;
verify the software description in accordance with constraints imposed by middleware specifications;
automatically create, based on the verified software description, a hierarchy of entity types and associations among the entity types compliant with the middleware specifications; and
output the entity types and the associations as the ETF for subsequent generation of a configuration of the middleware for availability management.

12. The computer system of claim 11, wherein the computer system is further operative to:
map a component of the software into an ETF component type;
map an interface provided by the component of the software into a component service type; and
associating the component service type with the ETF component type.

13. The computer system of claim 12, wherein the computer system is further operative to:
create a service type that groups all of the component service types provided by an independent ETF component type.

14. The computer system of claim 11, wherein the interfaces and dependency include an interface collocation dependency between multiple components of the software, wherein the multiple components are mapped to corresponding ETF component types having associated ETF component service types, and wherein the computer system is further operative to:
create a service type that groups the associated component service types; and
create a service unit type that groups the corresponding ETF component types.

15. The computer system of claim 11, wherein the computer system is further operative to:
generate an error indication when the software description violates at least one of the constraints imposed by the middleware specifications; and
automatically create the ETF when no error is detected in the software description.

16. The computer system of claim 11, wherein the interfaces include a provides interface through which a component provides service, and a requires interface indicating that a component requires service.

17. The computer system of claim 11, wherein the interfaces and dependency include one or more of the following: a middleware interface for registering and interacting with the middleware, a proxy interface provided by a proxy component that mediates interactions between the middleware and a proxied component, and a container interface provided by a container component that serves as an execution environment to contained components.

18. The computer system of claim 11, wherein the interfaces and dependency include a checkpoint interface, which is provided by a checkpoint agent to deliver checkpoint service of the middleware to a component.

19. The computer system of claim 11, wherein the computer system is further operative to generate configuration requirements from the verified software description.

20. The computer system of claim 11, wherein the software description is in a modeling language extended from a Unified Modeling Language (UML).
